(19) United States
(12) Patent Application Publication
(10) Pub. No.: US 2026/0211412 A1
(43) Pub. Date: Jul. 23, 2026

(54) ROOT CAUSE ANALYSIS OF ANOMALIES IN TURBOMACHINES

(71) Applicant: NUOVO PIGNONE TECNOLOGIE - S.R.L., Florence (IT)

(72) Inventors: Giacomo VENERI, Florence (IT); Valentina GORI, Florence (IT); Laure BARRIERE, Florence (IT); Valeria BALLARINI, Florence (IT); Andrea GARDETTO, Florence (IT)

(21) Appl. No.: 19/142,499

(22) PCT Filed: Dec. 22, 2023
(86) PCT No.: PCT/EP2023/025556

§ 371 Date: Jun. 23, 2025

(30) Foreign Application Priority Data
Dec. 27, 2022 (IT) 102022000026847

(51) Int. Cl. G05B 23/02; G01M 15/14

(52) U.S. Cl. CPC G05B 23/0275; G01M 15/14; G05B 23/0254

(57) ABSTRACT

The innovative method allows to determine root cause of an anomaly in a turbomachine and comprises the steps of: a) receiving measurement data from a set of feature sensors installed on the turbo machine relating to a time frame, b) receiving an identifier of a target feature sensor, the anomaly appearing in its measurement data, c) receiving start time and end time of a non-anomalous time subframe, d) receiving start time and end time of an anomalous time subframe, e) receiving identifiers of a plurality of feature sensors associated to features of the turbo machine that could be root causes of the anomaly, and f) deriving at least one feature of the turbo machine to be considered a root cause of the anomaly based on “contrastive analysis” of “feature importance” values of the feature sensors during the non-anomalous and the anomalous time subframes.

### TECHNICAL FIELD

The subject matter disclosed herein relates to root cause analysis of anomalies in turbomachines.

### BACKGROUND ART

Even if a turbomachine is designed so to avoid anomalies and maintenance is aimed at preventing anomalies, anomalies do occur in turbomachines during their operation. An anomaly is a situation in a machine far from standard operability; a first example of anomaly is a vibration at a certain location of a machine having an amplitude higher than normal vibration amplitude at that location; a second example of anomaly is a rotation speed of a certain component of a machine higher than normal rotation speed amplitude of that component; a third example of anomaly is a temperature at a certain location of a machine having a value higher than normal temperature at that location; a fourth example of anomaly is a pressure in a certain duct or cavity of a machine having a value higher than normal pressure in that duct or cavity; a fifth example of anomaly is a flow in a certain duct of a machine having a value higher than normal flow in that duct or cavity. The expression “far from” should be interpreted as meaning that the difference between the standard value, e.g. the rated value, and the actual value is greater than a predetermined difference, e.g. a predetermined percentage difference; such predetermined difference is typically different from parameter to parameter, and may depend also for example on the operating status of machine.

Root cause analysis of anomalies in turbomachines, i.e. finding the reason why an anomaly in a turbomachine occurred in the past or is occurring at present, is very important for both the manufacturer and the user, but is very difficult to carry out reliably. The complexity of a turbomachine, for example a compressor or a turbine, and of the contest, for example in an Oil & Gas application, wherein it is installed and operates make this task even more difficult. In some cases, it is difficult even only precisely identifying an anomaly.

The technical literature discloses computer-implemented methods and computer-based systems that aim at fully automatically identifying anomalies in machines. Some anomalies are relatively easy to be identified. Other anomalies are difficult to be identified. In order to perform effectively and reliably, a common possibility is to carry out extensive testing of and training on each machine of interest. Usually, deep knowledge of the machine of interest and of the contest wherein it is installed and operates is a big advantage for a reliable solution.

Similarly, the technical literature discloses computer-implemented methods and computer-based systems that aim at fully automatically finding root causes of anomalies in machines. Such task is much more difficult, and effectiveness and reliability are much more challenging. Even in this case, extensive testing and training may be used for solving the problem.

Therefore, it would be desirable to have an easier approach root cause analysis of anomalies in turbomachines, in particular turbomachines for Oil & Gas applications, without sacrificing effectiveness and reliability.

### SUMMARY

According to a first aspect, the subject matter disclosed herein relates to a computer-implemented method for root cause analysis of an anomaly in a turbomachine; the method comprises the steps of: a) receiving measurement data from a set of feature sensors installed on the turbomachine relating to a time frame, b) receiving an identifier of a target feature sensor, the anomaly appearing in its measurement data, c) receiving start time and end time of a non-anomalous time subframe when the anomaly does not occur, d) receiving start time and end time of an anomalous time subframe when the anomaly does occur, e) receiving identifiers of a plurality of feature sensors associated to features of the turbomachine that could be root causes of the anomaly, and f) deriving at least one feature of the turbomachine to be considered a root cause of the anomaly based on “contrastive analysis” of “feature importance” values of the feature sensors during the non-anomalous and the anomalous time subframes. The terms “contrastive analysis” and “feature importance” will be explained later in the detailed description.

According to other aspects, the subject matter disclosed herein relates to a computer-based system and a turbomachine arrangement wherein such method is implemented.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a schematic block diagram of an embodiment of an innovative turbomachine arrangement including an innovative system,

FIG. 2 shows a flowchart of an embodiment of an innovative method for root cause analysis of an anomaly in a turbomachine, and

FIG. 3 shows a flowchart of a possible embodiment of one specific step of the method of FIG. 2.

### DETAILED DESCRIPTION OF EMBODIMENTS

As explained above, identifying an anomaly in a turbomachine is difficult and determining its root cause is even more difficult if a reliable result is desired. Therefore, it has been conceived to limit the task only to a simplified, still challenging, problem, but avoiding preliminary testing and training on the machine or machines. It is assumed that A) anomalies are identified, i.e. anomalous periods and non-anomalous periods are known, and B) possible causes for an anomaly are known. The task is to choose the best cause, i.e. the cause that is likely to be the true root cause of the anomaly. In general, the number of possible causes of an anomaly is high, for example from e.g. 10 to e.g. 100, and depends from anomaly to anomaly; for example, a vibration higher than normal may be caused by an anomalous flow value in any of a set of ducts, by an anomalous pressure value in any of a set of ducts, by an anomalous rotation speed of any of a set of components; the task is to choose which of the duct flows or duct pressure or component rotation speed caused or is causing an anomaly identified at a certain time. According to the subject matter disclosed herein, the problem is solved by “contrastive analysis”, i.e. comparing anomalous and non-anomalous periods, and does not require any preliminary knowledge of any anomaly, in particular it requires no preliminary training.

Reference now will be made in detail to embodiments of the disclosure, examples of which are illustrated in the drawings. The examples and drawing figures are provided by way of explanation of the disclosure and should not be construed as a limitation of the disclosure. In fact, it will be apparent to those skilled in the art that various modifications and variations can be made in the present disclosure without departing from the scope or spirit of the disclosure. In the following description, similar reference numerals are used for the illustration of figures of the embodiments to indicate elements performing the same or similar functions. Moreover, for clarity of illustration, some references may be not repeated in all the figures.

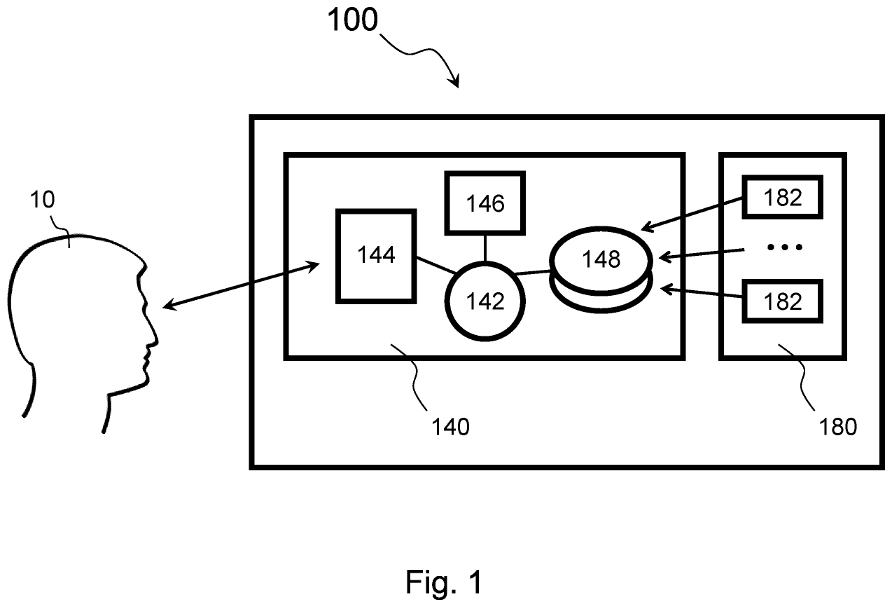

In FIG. 1, an embodiment of an innovative turbomachine arrangement 100 is shown in a very schematic way together with a user 10 thereof that interacts with arrangement 100. Arrangement 100 comprises a turbomachine 180 and an innovative computer-based system 140. User 10 may be an employee of a company that has manufactured turbomachine 180, or an employee of a company in charge of testing turbomachine 180, or an employee of a company that manages a plant where turbomachine 180 is installed. More in general, user 10 is a person or a team of persons interested in determining the root cause of an anomaly that occurred or is occurring in turbomachine 180; such need may repeat from time to time, at any new anomaly.

Arrangement 100 and variants thereof will be described more in detail afterwards. It is important to anticipate now that turbomachine 180 includes a set of feature sensors 182 installed thereon; the number of sensors 182 is high, for example 100-1000; sensors 182 repeatedly perform measurements of “features”, that may also be called “variables”, of the turbomachine such as for example temperatures, pressures, volumetric and mass flows, displacements, speeds (e.g. rotation speeds), accelerations, vibrations, valve opening levels, IGV set angular positions, IGV detected angular positions, gas compositions, burner statuses. Typically, sensors 182 are “real” sensors, i.e. devices that perform a measurement inside the turbomachine and determine/output a (analog or digital) signal whose amplitude corresponds to the value measured. Alternatively, according to the subject matter disclosed herein, one or more of the sensors may be so-called “virtual” sensors; as known, a “virtual” sensor is a piece of software running in a computer (it may be the same computer carrying out the inventive method) that repeatedly calculates e.g. a formula using as input data from one or more “real” sensors and producing as output data of the “virtual” sensor as if a machine would have a “real” sensor on-board instead of the “virtual” sensor.

System 140 receives in some way measurement data from sensors 182. FIG. 1 shows arrows between turbomachine 180 and system 140 that may be interpreted as (wired or wireless) connection(s), so that measurement data are received from turbomachine 180 directly. However, according to some embodiments, measurements data may be collected for example by a computer system (not shown in FIG. 1) at a certain time and then transferred to computer system 140 at a later time through a (wired or wireless) computer connection or through a data storage device just for analysis.

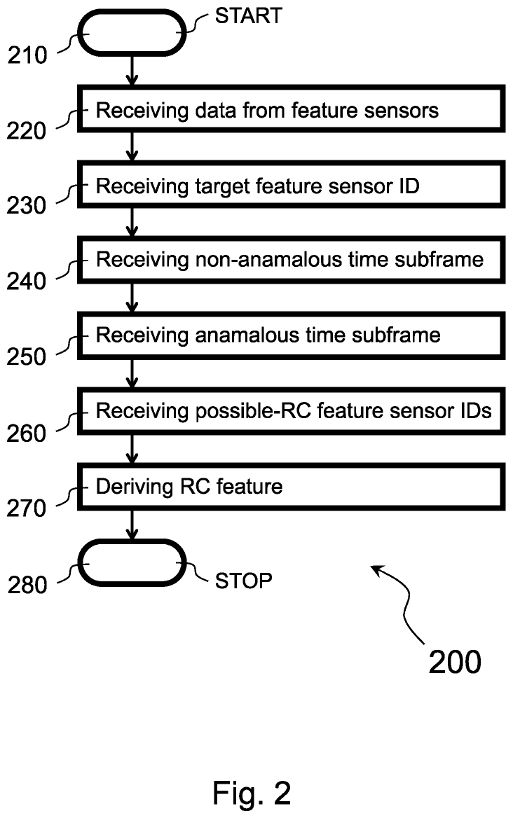

FIG. 2 shows a flowchart 200 of an embodiment of an innovative method for root cause analysis of an anomaly in a turbomachine, for example turbomachine 180 in FIG. 1; it is a computer-implemented method that may be implemented for example by computer system 140 in FIG. 1. The path of flowchart is followed from START block 210 to STOP block 280 at each anomaly identified—in general, it is to be expected that during operation of a turbomachine several anomalies occur typically one after the other; therefore, it may be repeated for example during study or examination of a turbomachine (i.e. offline) or during testing of the turbomachine or during operation of the turbomachine.

The innovative method comprises the steps of:
a) receiving (block 220) data from a set of feature sensors installed on the turbomachine, the data corresponding to measurements performed by the feature sensors of the set of feature sensors within a time frame,
b) receiving (block 230) an identifier of a feature sensor of the set of feature sensors, wherein the anomaly appears in measurement data from at least this feature sensor and this feature sensor is a target feature sensor for the anomaly,
c) receiving (block 240) a first start time and a first end time of a first time subframe, the first time subframe being contained within the above-mentioned time frame, wherein the anomaly does not occur during the first time subframe,
d) receiving (block 250) a second start time and a second end time of a second time subframe, the second time subframe being contained within the above-mentioned time frame, wherein the anomaly does occur during the second time subframe,
e) receiving (block 260) identifiers of a plurality of feature sensors of the set of feature sensors associated to features of the turbomachine that could be root causes of the anomaly, and
f) deriving (block 270) at least one feature of the turbomachine to be considered a root cause of the anomaly based on “contrastive analysis” of “feature importance” values of the feature sensors of the plurality of feature sensors during the first time subframe and during the second time subframe.

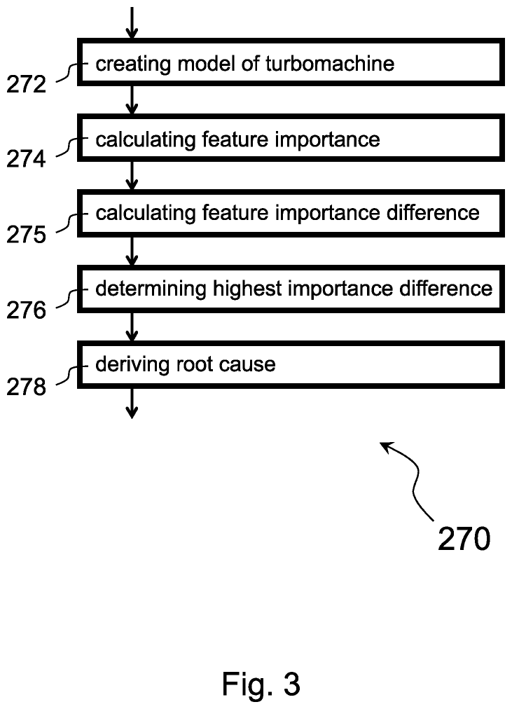

“Contrastive analysis” at step “f” means comparing anomalous periods and non-anomalous periods, in particular, “features importance” at anomalous periods and at non-anomalous periods; step “f” will be better explained later with the aid of FIG. 3. The term “feature importance” means the degree or level of the effect of an input feature, i.e. variable, on the output feature, i.e. variable. If a system is considered as a black box with several input variables and one output variable, any specific output value may be considered due to the effects of all input values; however, each input value may have contributed differently to the specific output value. The system may be associated to a “prediction model”, that is usually very complex, and to an “explanation model”, that should be quite simple for being easily understandable. A very effective type of “explanation model” is a linear function of binary variables so that “additive feature attribution methods” may be implemented. More details on this subject may be found e.g. in the article by Scott M. Lundberg and Su-In Lee, entitled “A unified approach to interpreting model predictions” in the Proceedings of the 31st International Conference on Neural Information Processing Systems—NIPS 2017.

Specifically, in step “f”, at least one feature is chosen within a plurality of features, i.e. the features associated to the plurality of feature sensors mentioned at step “e”. In particular, at step “f”, a feature importance difference value of each feature sensor of the plurality of feature sensors is calculated and a highest feature importance difference value is determined therefrom. The reason why more than one feature may be obtained at step “f” will be explained later and is related to the fact that the innovative method may be used as an aid to a human being (or a team of human beings, e.g. technical experts) so that the final decision of which is the true root cause may be left for example to such human being (or a team of human beings, e.g. technical experts) based also on his expertise or may require further tests and/or investigations.

“Contrastive analysis” at step “f” according to the subject matter disclosed herein comprises:
calculating a feature importance value of each feature sensor of said plurality of feature sensors, in particular as the feature contribution to the regression of the target variable, during said first time subframe and during said second time subframe,
calculating a feature importance difference value of each feature sensor of said plurality of feature sensors, the feature importance difference value being a difference between the feature importance value during said first time subframe and the feature importance value during said second time subframe, and
determining a high or the highest feature importance difference value between the calculated feature importance difference values.

Advantageously, feature importance values are calculated based on a model (typically, an explanation model) of the turbomachine that is a linear function of binary variables, the binary variables corresponding to features of the turbomachine corresponding to said plurality of feature sensors, as mentioned in e.g. the already cited article by Scott M. Lundberg and Su-In Lee.

According to some typical embodiments, one or more or all of the “receiving” steps, i.e. steps “b” and “c” and “d” and “e”, includes receiving inputs from a user, for example user 10 in FIG. 1. This is especially true for steps “b” and “e”, i.e. the identification of the target feature and the identification of possible root cause features.

According to some typical embodiments, the occurrence of an anomaly is judged by a human being based on human observation of the turbomachine and for example its measurement data.

Usually, the second time subframe, i.e. the “anomalous” time subframe, follows the first time subframe, i.e. the “non-anomalous” time subframe. Indeed, the anomaly may have started even at the end of the first time subframe, but its effects are not apparent during the first time subframe, not even at the end of the first time subframe. If a human being makes a wrong judgement, the innovative method still provides good results if only few pieces of measurement data in the first time subframe are collected while the anomaly is occurring.

In the above steps “b” and “e”, reference is made to “identifiers” as means for identifying sensors and features of the turbomachine.

In the above steps “c” and “d”, reference is made to “start time” and “end time” as means for identifying “time subframes”. Equivalently, a “time subframe” may be identified for example by a “start time” and a “duration” or an “end time” and a “duration”.

According to advantageous embodiments, for example the embodiment of FIG. 3, step “f” comprises the sub-steps of:
f1) creating (block 272) a model (typically, an explanation model) of the turbomachine based on the measurement data received (in particular measurements data in the first time subframe, i.e. the “non-anomalous” time subframe), the model having as input at least features of the turbomachine corresponding to the plurality of feature sensors and as output at least a feature of the turbomachine corresponding to the target feature sensor,
f2) calculating (block 274) a feature importance value of each feature sensor of the plurality of feature sensors, separately during the first time subframe and the second time subframe, with respect to measurement data from at least the target feature sensor, based on the model created at sub-step “f1”,
f3) calculating (block 275) a feature importance difference value of each feature sensor of the plurality of feature sensors, the feature importance difference value being a difference between a feature importance value during the first time subframe and a feature importance value during the second time subframe, based on the feature importance values calculated at sub-step “f2”,
f4) determining (block 276) a highest feature importance difference value between the feature importance difference values calculated at sub-step “f3”, and
f5) deriving (block 278) from the highest feature importance difference value determined at sub-step “f4” an associated feature of the turbomachine to be considered root cause of the anomaly.

The model at sub-step “f1” is advantageously a regressive model that, more advantageously, may be implemented through a recurrent neural network, in particular a neural network of the type LSTM (=“Long Short-Term Memory”). Such model, in particular the neural network, is trained to predict the target feature based on measurements data of the input features sensors using data received at step “a”.

According to advantageous embodiments, sub-step “f2” is implemented through an explainability method applied on top of the model created at sub-step “f1” and based on a Shapley values related technique, in particular SHAP values (see e.g. the already cited article by Scott M. Lundberg and Su-In Lee that provides general explanations on Shapley values related techniques and specific description of SHAP values). Such explainability method arises from game theory and basically attributes to each feature a value corresponding to the change in the expected model prediction when conditioning on that feature. The basic procedure behind such explainability method is to retrain the model on all possible feature subsets S of F, where F is the set of all features, and to assign an importance value to each feature, that represents the effect on the model prediction of including that feature. To compute this effect, a model is trained with that feature present, and another model is trained with the feature withheld. Since the effect of withholding a feature depends on other features in the model (collinearity effect), the preceding differences are computed for all possible features subsets. The Shapley values are then computed and used as feature attributions. They are a weighted average of all possible differences of predictions obtained with and without a certain feature. Usually this calculation is approximated in order to speed up the procedure.

Preferably, the working conditions of the turbomachine in the first time subframe and the working conditions of the turbomachine in the second time subframe are similar. Similarity may be based on the values of input features; for example, similar conditions may mean, for a compressor, within a same rotation speed range and/or within a same suction pressure range and/or within a same discharge pressure range. Similarity may be based on the values of output features, i.e. on effects; same conditions may mean that, if there should be no anomaly, the target feature should have the same value or be within the same value range. From the practical point of view, similarity may be based on time proximity; similarity is likely if the first time subframe and the second time subframe are consecutive or timely close to each other (for example, time distance less than 10% or 20% or 50% or 100% of duration of first time subframe or second time subframe).

According to some advantageous embodiments:
at sub-step “f4”, a set of highest feature importance difference values is determined, and
at sub-step “f5”, the feature importance difference values of the set of highest feature importance difference values are ranked and correspondingly associated features of the turbomachine are ranked as root causes of said anomaly.
   In this way, some features are provided as possible root causes of the anomaly and they are ordered according to the probability of being the true root cause.

According to some advantageous embodiments, at sub-step “f5”, a confidence value is determined for the determination of the root cause of the anomaly. In particular, sub-steps “f1” and “f2” and “f3” and “f4” and “f5” are repeated based on different initialization of the weights of the neural network; for each repetition a distinct feature ranking is obtained; for each feature a mean value of its ranking position is determined and a variance of its ranking position; the confidence of a feature being the root cause of the analysis is the inverse of its variance.

The method for root cause analysis of an anomaly in a turbomachine herein described and claimed may be implemented through a computer-based system, for example system 140 in FIG. 1 being configured to carry out method. The system may comprise essentially a processor, for example processor 142 in FIG. 1, a memory, for example memory 146 in FIG. 1, connected to processor 142 and configured to store program and data, and a human I/O interface, for example human I/O interface 144, connected to processor 142. These components 142, 144 and 146 are the key components of a computer; therefore, system 140 may be for example a so-called “workstation” or a so-called “server” or even a so-called “cluster” of computers. In order to carry out the innovative method, an appropriate computer program is stored in the memory. In order to carry out the method, input from user 10 is received from the human I/O interface and sent to the processor. As already described, the innovative system is configured to receive in some way measurement data from a turbomachine (see e.g. arrows in FIG. 1). A typical possibility is that system 140 includes a database 148 for storing data, specifically measurement data, from one or more turbomachines. Transferring measurement data from turbomachines to a computer located remotely from the turbomachines and storing them in a database positioned inside the computer or coupled to the computer is known in the art and is outside of the scope of protection of the present patent application.

According to some embodiments, the innovative system is configured to carry out the innovative method offline. In other words, measurement data may have been transferred from the turbomachines to the database well before (for example one hour, or one day or one month before) being processed according to the method disclosed herein.

According to other embodiments, the innovative system, for example system 140 in FIG. 1, is configured to carry out the innovative method during operation of the turbomachine (or the turbomachines), for example turbomachine 180 in FIG. 1.

According to possible embodiments, the innovative system, for example system 140 in FIG. 1, may be configured to identify one or more anomalies (not necessarily all) or one or more types of anomaly (not necessarily all) in the turbomachine, for example turbomachine 180 in FIG. 1, in an automatic way. For example, an appropriate piece of software may be stored in the memory of the system, for example memory 146 in FIG. 1, in order to perform such task and provide info to the piece of software implementing the innovative method. The appropriate piece of software may be also able to identify an “anomalous” time subframe and a “non-anomalous” time subframe and provide them to the piece of software implementing the innovative method.

As shown in FIG. 1, the innovative system may be integrated in a turbomachine arrangement, for example arrangement 100 in FIG. 1. Such system comprises essentially a turbomachine, for example turbomachine 180 in FIG. 1, and an innovative system, for example system 140 in FIG. 1.

Understanding a root cause of an anomaly in a turbomachine is useful not only in order to get more/better knowledge of this turbomachine and/or to design better this turbomachine or a similar turbomachine (in particular one or more turbomachine components). In fact, based on the root cause (or the causes) identified, according to some embodiments, it is possible to trigger an alert/alarm (audible or visual) for a user when the turbomachine is operating (in the field or during testing) and/or to take some actions for example though a computer controlling on the turbomachine or on one or more sub-systems of the turbomachine or coupled to the turbomachine. An action may be motivated for example by a safety concern or an efficiency objective. An action may be for example shut down of the turbomachine or activation of a security system or sub-system or change in the regulation of a component (e.g. opening or closing of a valve).

1. A computer-implemented method for root cause analysis of an anomaly in a turbomachine, wherein the method comprises the steps of:
a) receiving data from a set of feature sensors installed on the turbomachine, the data corresponding to measurements performed by the feature sensors of said set of feature sensors within a time frame,
b) receiving an identifier of a feature sensor of said set of feature sensors, wherein said anomaly appears in measurement data from at least said feature sensor and said feature sensor is a target feature sensor for said anomaly,
c) receiving a first start time and a first end time of a first time subframe, the first time subframe being contained within said time frame, wherein said anomaly does not occur during said first time subframe,
d) receiving a second start time and a second end time of a second time subframe, the second time subframe being contained within said time frame, wherein said anomaly does occur during the second time subframe,
e) receiving identifiers of a plurality of feature sensors of said set of feature sensors associated to features of the turbomachine that could be root causes of said anomaly, and
f) deriving at least one feature of the turbomachine to be considered a root cause of said anomaly based on contrastive analysis of feature importance values of the feature sensors of said plurality of feature sensors during said first time subframe and during said second time subframe; wherein said contrastive analysis at step “f” comprises:
calculating a feature importance value of each feature sensor of said plurality of feature sensors, during said first time subframe and during said second time subframe,
calculating a feature importance difference value of each feature sensor of said plurality of feature sensors, the feature importance difference value being a difference between the feature importance value during said first time subframe and the feature importance value during said second time subframe, and
determining a high or the highest feature importance difference value between the calculated feature importance difference values.

2. The method of claim 1, wherein feature importance values are calculated based on a model of the turbomachine that is a linear function of binary variables, the binary variables corresponding to features of the turbomachine corresponding to said plurality of feature sensors.

3. The method of claim 1, wherein step f comprises the sub-steps of:
f1) creating a model of the turbomachine based on said measurement data, said model having as input at least features of the turbomachine corresponding to said plurality of feature sensors and as output at least a feature of the turbomachine corresponding to said target feature sensor,
f2) calculating a feature importance value of each feature sensor of said plurality of feature sensors, during said first time subframe and during said second time subframe, with respect to measurement data from at least said target feature sensor, based on said model created at sub-step “f1”,
f3) calculating a feature importance difference value of each feature sensor of said plurality of feature sensors, the feature importance difference value being a difference between a feature importance value during said first time subframe and a feature importance value during said second time subframe, based on the feature importance values calculated at sub-step “f2”,
f4) determining a highest feature importance difference value between the feature importance difference values calculated at sub-step “f3”, and
f5) deriving from the highest feature importance difference value determined at sub-step “f4” an associated feature of the turbomachine to be considered root cause of said anomaly.

4. The method of claim 3, wherein said model at sub-step “f1” is a regressive model.

5. The method of claim 4, wherein said model at sub-step “f1” is implemented through a recurrent neural network.

6. The method of claim 5, wherein said model at sub-step “f1” is implemented through a neural network of the type LSTM.

7. The method of claim 1, wherein sub-step “f2” is performed through Shapley values related techniques.

8. The method of claim 1, wherein the working conditions of the turbomachine in said first time subframe and the working conditions of the turbomachine in said second time subframe are similar.

9. The method of claim 3, wherein at sub-step f4, a set of highest feature importance difference values is determined, and
wherein at sub-step f5, the feature importance difference values of said set of highest feature importance difference values are ranked and correspondingly associated features of the turbomachine are ranked as root causes of said anomaly.

10. The method of claim 3, wherein at sub-step f5 a confidence value is determined for the determination of the root cause of said anomaly.

11. A computer-based system configured to carry out the root cause analysis method according to claim 1.

12. A computer-based system configured to carry out the root cause analysis method according to claim 1 during operation of the turbomachine.

13. The computer-based system of claim 12, wherein it is configured to trigger an alert/alarm based on a root cause identified through the method.

14. The computer-based system of claim 12, wherein it is configured to take actions on the turbomachine or on one or more sub-systems of the turbomachine or coupled to the turbomachine based on a root cause identified through the method.

15. A turbomachine arrangement comprising a turbomachine and a system according to claim 11.

16. A turbomachine arrangement comprising a turbomachine and a system according to claim 12.
